(19) United States
(12) Patent Application Publication
(10) Pub. No.: US 2010/0225654 A1
(43) Pub. Date: Sep. 9, 2010

(54) Theatre Seatback Display

(76) Inventor: Robert J. Theis, Manlius, NY (US)

Correspondence Address: BOND, SCHOENECK & KING, PLLC, ONE LINCOLN CENTER, SYRACUSE, NY, 13202-1355, US

(21) Appl. No.: 12/719,242

(22) Filed: Mar. 8, 2010

Related U.S. Application Data
(60) Provisional application No. 61/157,925, filed on Mar. 6, 2009.

(51) Int. Cl. G06Q 30/00; G06F 13/14

(52) U.S. Cl. 345/520; 705/14.4

(57) ABSTRACT

The present invention is directed to improvements on display hardware and/or user presentation interface systems for audience gathering places, such as theatres, stadiums, cinemas and auditoriums. The display hardware relates to the equipment used to distribute communications (such as advertising and audience feedback) throughout the audience gathering place and to (at least some of) the individual members of the audience. The user presentation interface systems involve the substance of the communications that are actually made to and/or from audience members. In this document the focus will be on theatre applications. One key insight is that while delivery of information to/from an audience member who has come to see a performance of some kind (for example, an opera) has the potential to be distracting, this process will be much less distracting, and can even be greatly enjoyment-enhancing, if each audience member has her or his own dedicated user interface presentation hardware (for example, seatback display, netbook plugged into her seat, headphones, etc.) at the individual level.

### RELATED APPLICATION

The present application claims priority to U.S. provisional patent application No. 61/157,925, filed on Mar. 6, 2009; all of the foregoing patent-related document(s) are hereby incorporated by reference herein in their respective entirety(ies).

### BACKGROUND OF THE INVENTION

1. Field of the Invention

The present invention relates to display hardware (see DEFINITIONS section) and user interface display systems (see DEFINITIONS section) for audience gathering places (see DEFINITIONS section), and, in some of its more particular aspects, to seatback displays for theatres that hold live shows for audiences.

2. Description of the Related Art

It is conventional to have dynamic advertising displays, such as LCD screen displays, in retail stores. For example, a newspaper article entitled “Digital Signage A Sign of The Times At Retail Stores” and dated Dec. 1, 2008 (“Digital Signage Article”) has reported that dynamic advertising displays have been in use in Wal-Mart stores. The article states that the system of displays is subject to “customization” and that “[s]hoppers will be able to react to the information and the network will be able to adjust the messaging to ensure it is as effective as possible.” A person quoted in the Digital Signage Article states that such displays are put in the vicinity of the merchandise for sale in retail stores because “retailers are striving to send brand messages ‘at the last moment of truth,’ right when they are deciding what to buy.” the article goes on to state that: “A Wal-Mart shopper looking to buy detergent, for example, might see an All ad on a screen near the detergent shelf.” The Digital Signage Article does not teach that its dynamic advertising displays could or would be used away from the vicinity of where products are being sold, and, indeed, teaches away from that with its repeated emphasis on the importance of putting the display as close as possible to the point where the shopper decides whether and/or which product to purchase.

A different conventional system involving a digital display is called the Electronic Libretto System, which is described at a Wikipedia entry (“ELS Wiki” published as of Feb. 27, 2008 at URL: http://en.wikipedia.org/wiki/Electronic_libretto) as follows: “The Electronic libretto system is used primarily in opera houses and is a device which presents translations of lyrics into an audience's language or transcribes lyrics that may be difficult to understand in the sung form. Since 1983, projected Supertitles or surtitles have been commonly used in opera or other musical performances and they have proven to be a commercial success in art forms such as opera which are generally sung in foreign languages. However, many people believed that surtitles interfered with the enjoyment of a performance, because they tended to find themselves following the titles and not giving their full attention to the stage. This problem was solved by the development of an electronic libretto system, which utilizes individual screens placed on the back of each seat, thus allowing patrons either to view a translation or to switch them off during the performance. Although initially developed by technicians at the Santa Fe Opera, the Metropolitan Opera was the first to install the system which they describe as Met Titles. The electronic libretto system was further developed and patented, in the US, as ‘Simultext’ by Figaro Systems of Santa Fe, N. Mex. with the Santa Fe Opera becoming the second house to adopt it after its 1997/98 refurbishment.”

One commercial embodiment of the Electronic Libretto System has a brand name and is being sold as a product known as “Simultext” (the name “Simultext” may be subject to trademark rights in the U.S. and/or other jurisdictions) by Figaro Systems (http://figaro-systems.com). The Figaro Systems website mentions patent litigation related to Electronic Libretto Systems. Opera houses such as the Valencia Opera House, the National Noh Theatre in Tokyo, the Vienna State Opera in Vienna, the Liceu in Barcelona, the Royal Opera House in London and the Teatro degli Arcimboldi and La Scala (both in Milan) are believed to have added the electronic titles, the latter providing English, and Italian translations in addition to the original language of the opera. It is believed that other companies have developed similar technologies, such as Sonoidea in Spain, Visutech in Denmark, Radio Marconi in Italy, 3Com in US and Rokko Denki in Japan. In the US, various of these systems are believed to now to be found at the Miami's Adrienne Arsht Center for the Performing Arts, Ellie Caulkins Opera House in Denver, Colo., at the Des Moines Metro Opera, the Seattle Opera, Kansas City's Lyric Opera, and in the Roy O. Disney Theatre, a part of the National Hispanic Cultural Center in Albuquerque, N. Mex. Reportedly, this technology has been expensive (about $1000 per seat) and intrusive (it can be done only during construction or renovation). This is why few theatres can use it. Reportedly, the installations of the Met, La Scala and the Arcimboldi, the Vienna State Opera, Liceu, and the Royal Opera House were possible with the donations of the philanthropist Alberto Vilar, at the time a majority shareholder of Figaro Systems. So far as can be determined, all of these conventional Electronic Libretto systems send the same display content (that is, the same translation text) to every seatback display in the theatre at the same time. This makes sense because when an audience is in an audience gathering place, the audience members are there to watch a common spectacle (for example, movie, sporting event) together and in unison so naturally the respective seatback displays of the audience members would and generally have shown the exact same display.

U.S. Pat. No. 6,760,010 (“Webb”) discloses: “[A]n apparatus and method for the simultaneous presentation of a performance script or other commentary, dialogue or visual information available in the original language or multiple translations which can be selected by the user on portable wireless devices.”

US patent application 2008/0256453 (“Fein”) discloses the following: “[A] projector and data processing method and system for recommending digital media content to a user. The method and system gather statistics about the preferences of the user and/or compare the user to population data to create recommendations in accord with the preferences of the population. The population data may be qualified by demographics or other factors classifying the user. Sources of the digital media content include radio broadcast television broadcast, global computer network content, email, and personal organizing software/programs.” Fein further discloses the following: “The system may be used in any place where personal information displays are used. For example, JetBlue (trademark symbol) airline incorporates individual LCD television screens into the seatbacks of its aircraft so each passenger may choose what to watch or listen to (each aircraft is connected via satellite dish to DirectTV (trademark symbol). and XM (trademark symbol) Radio). If a passenger has a subscription to Sports Illustrated (trademark symbol) magazine, then the LCD screen at the passenger's seat could be preset to ESPN (trademark symbol) Likewise, if a passenger is twenty-three years old, demographic data may show that twenty-three-year-olds are most likely to watch MTV (trademark symbol), and the LCD screen at the twenty-three-year-old passenger's seat could be preset to MTV (trademark symbol).”

U.S. Pat. No. 5,533,782 (“Goldman”) discloses: “A device for displaying and retaining informational literature and advertising material on the armrest of a stadium or theatre seat. The device includes a resilient flap under which the advertisements or materials are placed. The device may also include a cup-holder and display surfaces for advertisements.” It is noted that Goldman does not disclose anything about a dynamic display, because its displays are static. See the definition of “seatback display” in the DEFINITIONS section for more on this.

Other publications which may or may not be of interest may include: (i) US patent application (“USPA”) 2009/0115233 (“Tuccinardi”); (ii) USPA 2010/0045085 (“Jeffrey”); (iii) USPA 2010/0026892 (“Thijssen”); (iv) USPA 2009/0322125 (“Berger”); and/or (v) USPA 2009/0316057 (“Campbell”).

Description Of the Related Art Section Disclaimer: To the extent that specific publications are discussed above in this Description of the Related Art Section, these discussions should not be taken as an admission that the discussed publications (for example, published patents) are prior art for patent law purposes. For example, some or all of the discussed publications may not be sufficiently early in time, may not reflect subject matter developed early enough in time and/or may not be sufficiently enabling so as to amount to prior art for patent law purposes. To the extent that specific publications are discussed above in this Description of the Related Art Section, they are all hereby incorporated by reference into this document in their respective entirety(ies).

### BRIEF SUMMARY OF THE INVENTION

The present invention is directed to improvements on display hardware and/or user presentation interface systems for audience gathering places, such as theatres, stadiums, cinemas and auditoriums. The display hardware relates to the equipment used to distribute communications (such as advertising and audience feedback) throughout the audience gathering place and to (at least some of) the individual members of the audience. The user presentation interface systems involve the substance of the communications that are actually made to and/or from audience members. In this document the focus will be on theatre applications. One key insight is that while delivery of information to/from an audience member who has come to see a performance of some kind (for example, an opera) has the potential to be distracting, this process will be much less distracting, and can even be greatly enjoyment-enhancing, if each audience member has her or his own dedicated user interface presentation hardware (for example, seatback display, netbook plugged into her seat, headphones, etc.) at the individual level.

One example of display hardware is an LCD touchscreen screen built into the back of a stadium seat and connected in data communication (see DEFINITIONS section) with, and receiving display data, a remote server computer for generating displays on the LCD screen for viewing by an audience member sitting in the seat behind the seat with the built in display. Another example of display hardware is a USB port built into a theatre seat that is connected in data communication with, and receives display data from, a local area server computer for generating displays on the display screen of a laptop computer that the audience member sitting in that set brings to a play being performed in the theatre. Another example of display hardware numerous short range wireless transceivers (e.g., bluetooth transceivers), respectively built into numerous theatre seats, with each wireless transceiver being connected in data communication with, and receiving display data from, a local area server computer for generating displays on the display screen of a laptop computer that the audience member sitting in that set brings to a soft rock concert being performed in the theatre. These examples, of display hardware are non-exhaustive, and are provided to evoke some idea of the great variety of hardware types and deployment settings that may be involved in device hardware according to the present invention.

One example of a user interface presentation system is a system of hardware and software for providing a multiplicity of seats in an audience gathering place with display data for generating a user interface relating to advertising. This advertising-related interface may be one way, such as sound and video transmitted only for viewing and hearing by the audience member. Alternatively, this advertising-related interface may be two way, such as an xml based interface for display on browser software of the audience member's laptop computer that will both provide the user with sound, video and/or images, and also receive feedback data, such as keystrokes or webcam images, from the audience member. Another example of a user interface presentation system is a system of hardware and software for providing a multiplicity of seats in an audience gathering place with display data for generating a user interface relating to the substance of a performance that is taking place at the audience gathering place. This information relating to the substance take many forms, such as video images (for example, close up shots of actors and actresses in a play), audio output (for example, an audio stream directly from the mixing board at a jazz concert) or interactive media (for example, a chat room where people can discuss an academic lecture in real time as it is taking place). These examples, of a user interface presentation system are non-exhaustive, and are provided to evoke some idea of the great variety of user interface presentation system types and deployment settings that may be involved in user interface presentation according to the present invention.

In some embodiments of the present invention, each audience member (for example, each assigned seat) will get the same display data and/or user interface. In other embodiments, different audience members will get different display data and/or different user interfaces. While providing all audience members with the same display or user interface is simpler, providing different audience members with different displays and/or user interfaces can provider a richer, more rewarding experience for audience members and advertisers alike. For example, if a charity advertises at a play, and a charitable contribution can be made directly through the user interface respectively provided at each audience member's dedicated seatback touchscreen, then the charity may garner more contributions, as compared with a system that merely displaces an advertisement about the charity to each and every audience member. However, in order to keep track of separate contributions, each audience member would require her own interface so that it could be determined exactly who was contributing and how much each contributor agreed to contribute.

According to one aspect of the present invention, an audience gathering place communication system, for use in conjunction with an audience gathering place, includes a communication network hardware set and a network communication sub-system. The communication network hardware set is structured and/or programmed to implement a communication network at least substantially co-extensive in spatial scope with the audience gathering place. The communication network hardware set is structured and/or programmed to communicate at least display data to a plurality of display devices over the communication network. The network communication sub-system is in data communication with the communication network. The network communication sub-system is structured and/or programmed to provide display data to the communication network in a form suitable for communication to a plurality of display devices located in the audience gathering place. The network communication sub-system includes an advertising module structured and/or programmed to provide advertising-related display data to the communication network for communication to a plurality of display devices located in the audience gathering place.

According to a further aspect of the present invention, an audience gathering place system, for use at a performance for an audience, includes: multiple seatback displays, a video collection sub-system and a display programming sub-system. The multiple seatback displays include a first seatback display and a second seatback display. The video collection sub-system collects at least one video data stream(s) of the performance. The display programming sub-system comprises a video stream input module structured and/or programmed to receive the at least one video stream(s) from the video collection sub-system. The display programming sub-system further comprises a display assembly and output module structured and/or programmed to receive the at least one video stream(s) from the video stream input module and to generate display programming for at least some of the plurality of seatback displays corresponding to at least a portion of the at least one video stream(s).

### BRIEF DESCRIPTION OF THE DRAWINGS

The present invention will be more fully understood and appreciated by reading the following Detailed Description in conjunction with the accompanying drawings, in which:

FIG. 1 is a schematic of a theatre equipped with a seatback display system;

FIG. 2 is a block diagram of a display programming sub-system suitable for use with the seatback display system of FIG. 1;

FIG. 3 is a first screen shot of the visual portion of a first embodiment of a user interface according to the present invention;

FIG. 4 is a second screen shot of the visual portion of the first embodiment user interface;

FIG. 5 is a third screen shot of the visual portion of the first embodiment user interface; and

FIG. 6 is a fourth screen shot of the visual portion of the first embodiment user interface.

### DETAILED DESCRIPTION OF THE INVENTION

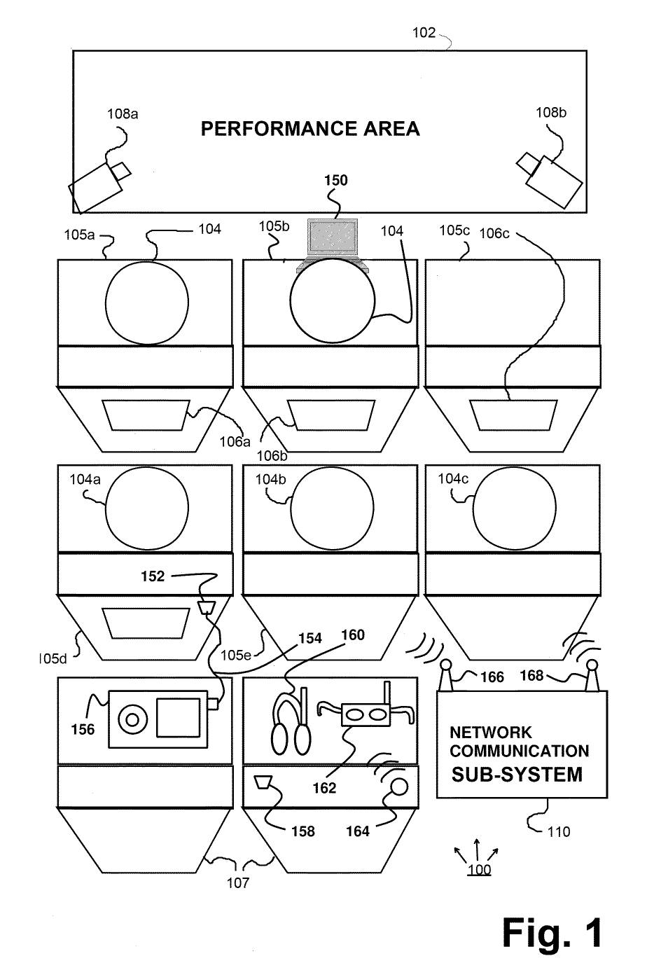

FIG. 1 shows an audience gathering place 100, in the form of a small theatre, equipped with a seatback display system, a wireless theatre-wide network, a couple of wired communication ports and a short range wireless transceiver dedicated to a single seat. Typically, a theatre would not have this great variety of display hardware and other user interface presentation hardware, but audience gathering place 100 has all of these forms of communication hardware to demonstrate some of the great variety of communication hardware types that are possible for use in various embodiments of the present invention.

As shown in FIG. 1, the audience gathering place includes: performance area 102; audience members 104 (including display-equipped audience members 104a,b,c); seats 105a,b,c,d,e, 107; seatback displays 106a,b,c; digital video cameras 108a, 108b; display programming sub-system 110; netbook computer 150; seatback theatre-wide network communication ports 152, 158; communication line 154; smartphone type device 156; bluetooth headphones 160; bluetooth goggles 162; bluetooth seatback wireless transceiver 164; theatre-wide wireless network receiver 166; and theatre-wide wireless network transmitter 168.

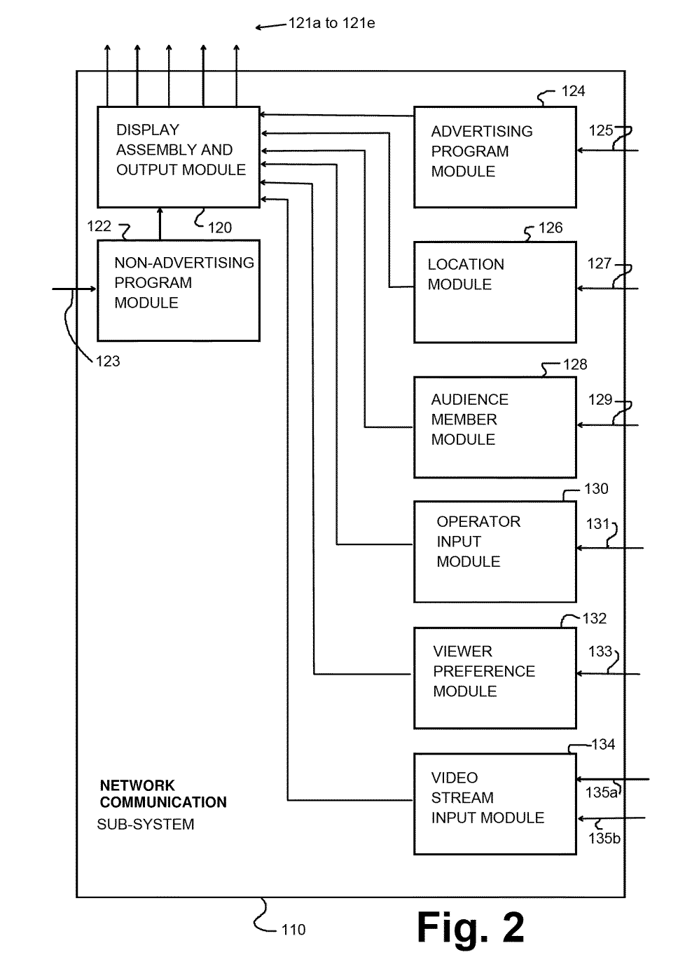

As shown in FIG. 2, display programming sub-system 110 includes: display assembly and output module 120; seatback display outputs 121a to 121e; non-advertising programming module 122; non-advertising programming input 123; advertising programming module 124; advertising programming input 125; location module 126; location module input 127; audience member module 128; audience member input 129; operator input module 131; viewer preference module 132; viewer preference input 133; video stream input module 134; and video stream inputs 135a, 135b.

The network communications sub-system may be in the form of a server computer with special purpose theatre-wide network software running upon it. In operation, network communication subsystem 110 provides a user interface for netbook 150, seatback displays 106, devices connected to communication ports 152, 156 and wireless device wirelessly linked to bluetooth transceiver 164.

The network communication sub-system has two way communication with the netbook via theatre-wide wireless network receiver 166 and theatre-wide wireless network transmitter 168. The netbook may be, for example, a WiFi equipped netbook brought to the theatre by an audience member for the purpose of participating in the theatre-wide network during the performance of a theatrical production. This type of display and user interface presentation hardware has some advantages. First, an audience member may prefer using her own computer for hygienic and/or privacy reasons. Second, the netbook typically has built in processing power for running browsers, flash applications (for example, flash video) and other software that can improve the network communication aspects of the audience member's performance experience. Third, a user can store personal data, such as a word processing document with notes, or a list of favorite websites in a browser, on her own netbook. Fourth, the netbook may be held and viewed in a manner that is less distracting for adjacent audience members. For example, the audience member would not be leaning over to touch a seatback touchscreen display. As another example, the netbook may be placed relatively close to the user's face so that it is largely outside the field of vision of adjacent audience members. Fifth, the netbook (at least in this example) is wireless, so that other audience members do not get tangled up in its wires. Sixth, this audience-provided netbook approach does not require that each audience member have a seat in front of her. For example, as shown in FIG. 1, the audience member holding netbook 150 does not have a seat in front of her. As a further example, in some audience gathering places, the seats are not aligned orthogonally so that a seatback display would not be directly in front of any particular audience member. As a further example, some audience gathering paces, such as bleachers, do not have seats and/or seatbacks.

There are also some features of audience-provided netbook approaches which may or may not be considered advantageous in a given application. One such feature is that the netbook has a keyboard. This makes it easy for the audience member to type in information for two way communication. However, the noise and/or motion of the typing might be considered as a distraction. If a theatre has a concert and streams sound from the sound mixing board to the netbook for the purpose of allowing a user to enjoy that quality audio signal through her headphones, then the user might use her netbook to make an unauthorized digital recording of the sound stream.

The seatback displays 106 may communicate with the network communication sub-system wirelessly, or through a wired connection built into the audience gathering place itself. The seatback displays may take the form of dumb terminals, or they may have some degree of processing power built into them, perhaps up to having the processing power of full-fledged computers. The seatback displays may be one way communication only (for example, only a visual display for the audience member in the seat behind the seat with the built in seatback display), or it may provide for two way communication (for example, a touchscreen seatback display). In some preferred embodiments of the invention, every seatback display will display the same display programming at the same time. In other preferred embodiments of the present invention, the various displays will display different display programming as will be further discussed below.

The digital video cameras are also in data communication with the display programming sub-system, and these cameras are positioned and oriented to capture video streams of a performance in performance area 102. The use of digital video cameras allow the display-equipped audience members 104 to see images of a performance on their respective displays from angles and/or distances that are different than what they can see directly through the space of the audience gathering place. This can help audience members see: (i) more visual detail than they otherwise could; and/or (ii) a different portion, profile or side of the performers or other performance subject matter than they otherwise could. This, in turn, can enhance the display equipped audience member's enjoyment, appreciation and/or educational benefit. the camera(s) may be manually operated, operated remotely in a dynamic manner and/or fixed and static camera(s).

As shown in FIG. 1, smartphone type device 156 is plugged into communication port 152 be cable 154. The communication port may be, for example, a USB style communication port. This type of display and user communication hardware has the disadvantage of the placement of a wire across space in front of the row of seats. However, communication port 158 shows that placement of the port can avoid this problem, especially when an audience member's dedicated port is placed directly on her own seat and not the one in front of her. A smartphone device has the advantage of being even smaller than a netbook, and therefore even less distracting to other audience members in the vicinity.

As shown in FIG. 1, the bluetooth headphone 160 and goggles 162 communicate with the bluetooth transceiver 164 that is built into the seat. If each seat were to have its own dedicated short range wireless data communication path, there would need to be some sort of digital handshaking so that devices of audience members in the same vicinity did not interfere with one another. This technology is likely to become more and more feasible as short-range wireless technology improves. The goggles are especially advantageous because they may allow data (for example, translated lyrics) to be superimposed on the audience member's direct view of the performance itself and/or they may allow for switching between a view of the live performance and a “virtual” display from the network communication sub-system with little or no movement of the head.

As shown in FIG. 2, display assembly and output module 120 actually creates the display data and/or other user interface output data that is transmitted to the various user interface presentation hardware (for example, seatback displays) that present communications (for example, visual display communications) directly to respective audience members. The video signals (and other user interface related data) output by module 120 could be: (i) analog or digital; (ii) packetized or non-packetized; (iii) connection-based or connectionless; (iv) in a form requiring a lot of processing power at the receiving end or not; and/or (v) in formats conventionally known or in formats to be developed in the future. The embodiment of FIG. 2 shows five separate output lines 121a to 121e, but, there may be more or fewer parallel outputs.

As shown in FIG. 2, module 120 may get its display programming, or content, and/or control and guidance in selecting content from many different sources as will now be explained. Non-advertising programming module 122 provides programming content, other than advertising and video streams. Some non-limiting examples of non-advertising content are as follows: libretto type lyrics; text-based commentary; text corresponding to pronouncements of a referee (for example, a hockey referee); text, images or video relating to other performances (for example, scores and highlights of other sporting events); entertainment programming (for example, entertainment programming shown prior to the start of a performance); and/or educational programming. Non-advertising programming module receives its data through input 123.

Advertising programming module 124 provides advertising-related programming content. Although this module is shown as a separate block from module 122 in order to illustrate the conceptual difference, it is noted that modules 122 and 124 may intermingle their data and may share hardware, software and/or input line(s). Advertising programming module receives its data through input 125.

Conventionally, when advertising is provided in an audience gathering place, the advertising is performed in the performance area. Conventionally, this conventional advertising in the performance area has been live performance (for example, an announcer thanking sponsors), by static display (ads on an outfield wall) or by dynamic display in the performance area (ads on a scoreboard display). The present invention recognizes that it is actually highly preferable to take that advertising away from the performance area and to put it in the form of a dynamic display on a seatback, especially if the audience gathering place is a theatre. The present invention recognizes that placing advertising in a dynamic seatback display in an audience gathering place makes the advertising much more palatable because it can be selectively avoided by audience members who see such advertising as an intrusion. This kind of avoidance may take the form of, for example, averting the eyes from the display; specifying a seat with no display when purchasing tickets for a performance; paying a surcharge to avoid advertising content; and/or turning off or shuttering the display (shutter not shown). despite the fact that audience members have greater options to effectively opt out of the advertising, it is believed that: (i) many will not choose to opt out; and (ii) few will opt out if the ads are visually pleasing, informative and/or creative; (iii) few will opt out of viewing the ads if they are well-targeted (this is further discussed below); and/or (iv) few will opt out of viewing the advertisements if they are mingled with non-advertising content that the audience member likes. Those who consider ads distasteful (for example, distasteful in connection with a classy opera performance) may actually consider them not at all distasteful when they are decoupled from the spectacle of a pitchman declaiming from the opera stage. The present invention allows advertisements to be presented in a more tasteful and less coercive context. This may make it possible to have advertisements and/or increased advertising in connections with types of performances (for example, Broadway musical plays, classical concerts) where advertisements are not currently conventional.

Location module 126 is only relevant in embodiments of the present invention where different display programming is sent to different displays. The location module provides information to assembly and output module 120 to determine, or at least help determine, what display programming will go to a given seatback. The location module focuses not on the identity of the audience member who will be watching the display, but rather on information related to the location of the seat within the audience gathering place where the audience member to be watching the display will sit. For example, if the relevant seat is to be unoccupied during a performance, then the location module may communicate that information to module 120 so that the associated seatback display does not turn on during the performance. As another example, if the relevant seat is an inexpensive seat, then the location module may communicate that information to module 120 so that advertising-related display programming targeted toward budget minded consumers can be provided on the relevant seatback display (that is, the seatback display directly in front of the inexpensive seat. As another example, if the relevant seat is close to the stage, then the location module may relate that information to module 120 so that streaming video giving an overview of the entire stage is made available on the relevant seatback display. On the other hand, if the relevant seat is distant from the stage, then the location module may relate that information to module 120 so that streaming video giving a closer view of the stage is made available on the relevant seatback display. As a further example, if the ticketholder for the relevant seat has paid an advertising opt-out surcharge, then the location module will communicate that information to module 120 so that no advertising-related display programming is included in the display programming sent to the relevant seat. The location module receives its data through input 127.

Audience member module 128 is only relevant in embodiments of the present invention where different display programming is sent to different displays. Although this module is shown as a separate block from location module 126 in order to illustrate the conceptual difference, it is noted that modules 126 and 128 may intermingle their data and may share hardware, software and/or input line(s). The audience member module provides information to assembly and output module 120 to determine, or at least help determine, what display programming will go to a given seatback. The audience member module focuses on the identity of the audience member who will be watching the display. For example, if the audience member is known to be a child, then the audience member module communicates this information to module 120 so that age appropriate display programming can be selected and sent to the child's display. As a further example, if it is known what other performances the audience member has attended in the past, then the audience member module communicates this information to module 120 so that targeted display programming (advertising and/or non-advertising). There are all kinds of audience member related information that may be of help in selecting display programming and/or display programming options to a given audience member, including, but not limited to: preferences registered by the audience member in an Internet database; purchasing history of the audience member; data legally purchased from data providers; preferences given by the audience member at the time of ticket purchase; and/or various kinds of demographic data. The audience member module receives its data through input 129.

Operator input module 130 allows a system operator to control the displays in various ways by inputting instruction data through input 131. As a simple example, in some embodiments of the present invention, the system operator may instruct all displays to be turned off at the beginning of a performance. As a further example, the system operator may manually choose a video stream to be sent to some or all seatback displays from among multiple video streams, so that the streaming video follows the action in a performance. This could be similar to the way televised sportscasts use multiple, manually controlled cameras to provide a display that helps the viewer see and follow the action. Traditionally, watching a performance (for example, a sports game) on television or seeing it live has been an either/or choice. The present invention allows an audience member to experience both, and the operator input module and the video stream input module 134 (discussed below) can help make this happen.

Audience member module 128 is primarily relevant in embodiments of the present invention where different display programming is sent to different displays. Viewer preference module 132 allows user to input information related to the display programming to display programming sub-system 110 through line 133. For example, the display equipped audience member may choose from various channels of display programming, much like a television viewer selects a channel on a teevee. As a further example, if streaming video of the performance is available, the viewer may choose which video stream she wants to watch. In more sophisticated embodiments, the user might get to perform some degree of pan and zoom type control on a chosen video stream. As a further example, the user could watch portions of the video stream in “replay” or “slow motion replay” form in order to see things she may have missed or not fully appreciated in real time.

Video stream input module 134 receives video streams from digital video cameras 108a,b (see FIG. 1) through inputs 135a,b, respectively.

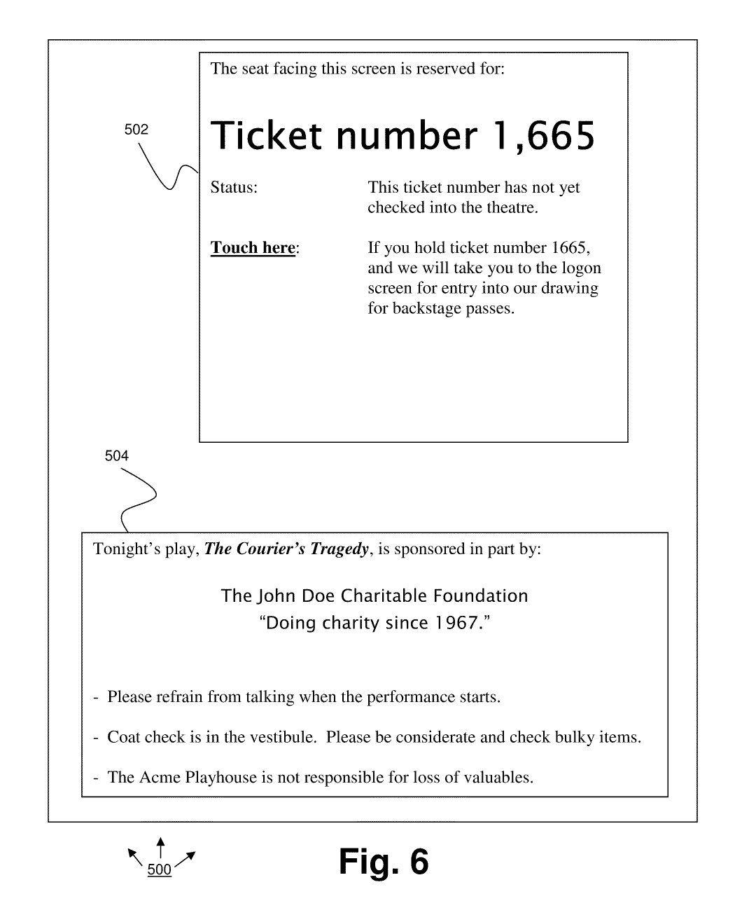

FIG. 6 shows an example of a screenshot 500 that corresponds to the display data of a user interface presented prior to a ticketholder's arrival at the theatre. Screen shot 500 includes: seat status indication block 502; and performance information block 504. Seat status information block informs ushers and patrons about the status of the ticket/ticket holder corresponding to the seat and provides the ticketholder a chance to log in when she arrives at her seat.

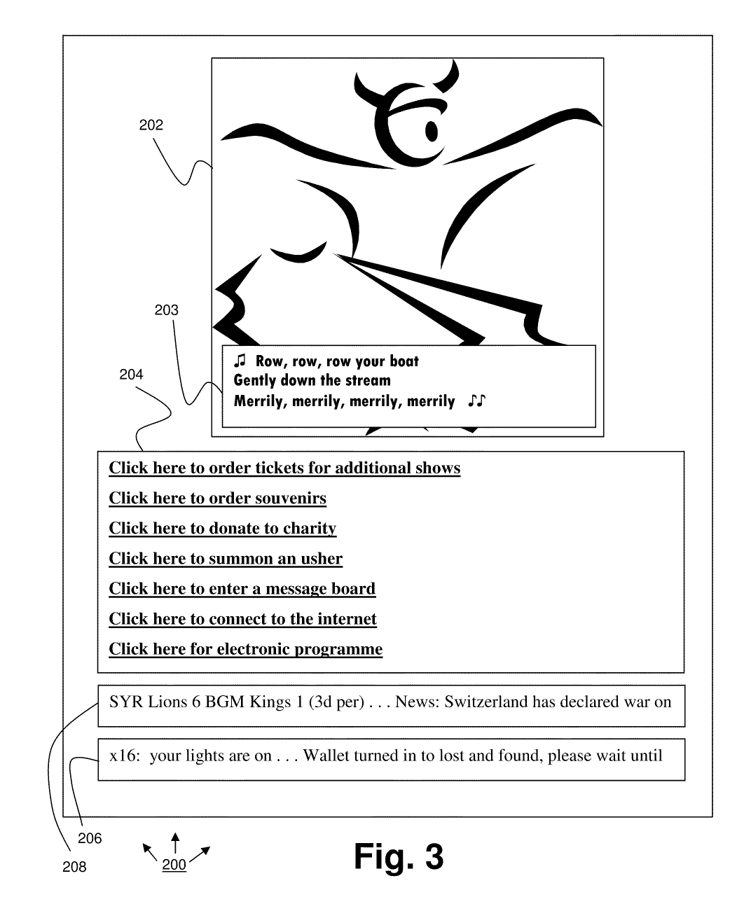

FIG. 3 shows an example of a screenshot 200 that corresponds to the display data of a user interface presented to the audience member during the performance of the play. Screen shot 200 includes: performance visuals block 202; audience member services block 204; news crawl block 208; and theatre info block 206. Performance visuals block includes not only video data from the cameras in the performance area (such as, actress close-ups), but also closed caption block 203 with a text crawl corresponding to the words of the performance, or perhaps a translation of those words into the native language. Audience member services block allows the user to choose from among several different services. For example, the audience member may want to go to the internet to find out more information about the play in order to better appreciate sub-texts or literary allusions in real time. Other services could be provided. For example, at a sporting event, there could be an option to order food and beverage to be brought to a given location in the bleachers. The news crawl block provides news so that the audience member does not fall behind on current events, such as sports scores, while enjoying the theatrical production. The theatre info block provides information related to the theatre and may reduce or eliminate the need for loudspeaker announcements.

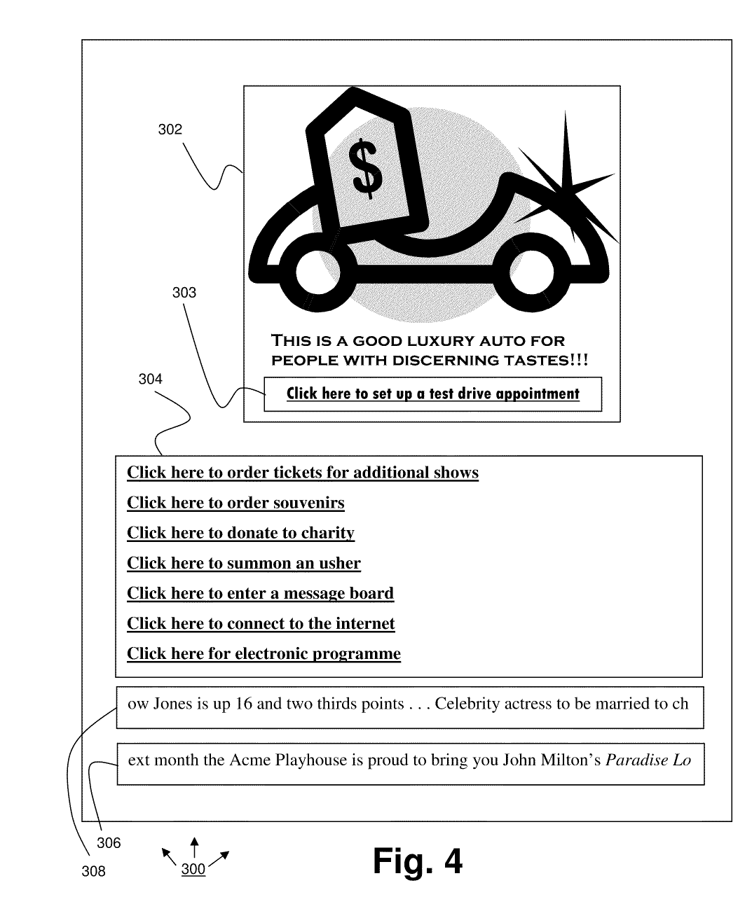

FIG. 4 shows an example of a screenshot 300 that corresponds to the display data of a user interface presented during an intermission in the play. Screen shot 300 includes: advertising visuals block 302; audience member services block 304; news crawl block 308; and theatre info block 306. The advertising block is noteworthy because it potentially represents a revenue stream for the audience gathering place, and perhaps even a way of raising the money needed to install the system of the present invention in the first place. This advertising is quite unlike conventional advertising in audience gathering places because there is more discretion for an audience member not to look at it. This is because the advertising appears only on an audience member's personal display. This means that the advertising is not generally conspicuous, but only conspicuous to an audience member who chooses to view it. In some applications, the audience member may choose to turn her seatback display off. However, for audience members who enjoy the enhancements of the seatback display, the advertisements will be even more conspicuous to that audience member on an individual basis, than, say, large screen LCD advertisements high on the walls of the lobby. Advertising visuals block 302 also includes data input block 303, which allows a user to communicate back to the advertiser to buy a product, request more information or other commerce-enhancing communications.

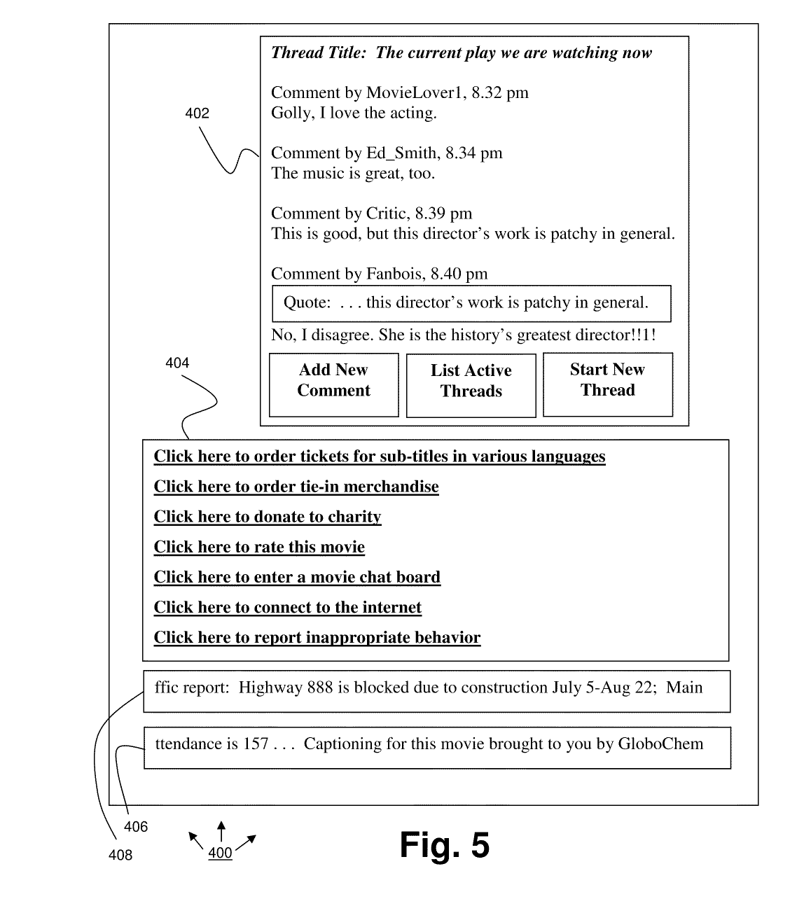

FIG. 5 shows an example of a screenshot 400 that corresponds to the display data of a user interface presented during a movie shown in a cinema. Screen shot 400 includes: chat board block 402; audience member services block 404; news crawl block 408; and cinema info block 406. This embodiment definitely works better when the audience members have user interface hardware that includes a keyboard, whether provided by the user or by the cinema (for example, built into the back of the seat). The chat board block is noteworthy because it potentially represents a new way of social networking. More specifically, the chat board blocks allows audience members to communicate with each other during the performance. Importantly, in preferred embodiments, participation in the chat room would be strictly limited to audience members actually at the same performance, and the chat would be closed off to the outside world.

This is exciting because it represents communication having an intermediate level of anonymity and selection bias that does not really exist in other settings. When compared to chatting with strangers on the internet it is less anonymous because the people participating in the chat know that they are chatting with people who are in the same theatre at the same moment. However, it is not quite as immediately non-anonymous as trying to strike up a conversation with a stranger at a cinema. It is believed that at least certain people would be more receptive to meeting new people at a performance, such as a movie or a sporting event if there was semi-anonymous chat first. This would allow some communication prior to agreeing to meet a new person (or rejecting that idea), but also to allow for chat communications to proceed quickly to a face to face meeting, in the relatively safe confines of a movie cinema or sporting event, if people decided that they actually wanted to meet based on a bit of message board style chat. In other words, this eliminates the awkwardness that can occur when people get to know each other exclusively through communication mediums like internet chatrooms, but have never met in real life. Whether the participants want to meet each other in person or not, they know that they are chatting with others who have enough in common to be present at the same performance, but perhaps not so much in common that conversation suffers from a lack of diversity of perspectives (as it might in a tightly regulated internet chatroom). All of this is thought to improve the quality of the chat and to enhance the possibility of meaningful interactions, relative to the pre-existing ways of interpersonal communication.

Also, and perhaps even more importantly, even anonymous chat can be rewarding and fun, even without having the objective of making any new friends. In other words, it may be fun to just “talk” about the movie, or the sporting event, or other performance, with others who are there during the time the performance lasts, and then never actually meeting the people. Some people like to talk during movies, and others (perhaps most people) do not. The present invention allows the people who like to talk to do this in a relatively noiseless manner, and thereby leave in peace those that do not like too much talk at a performance.

### DEFINITIONS

The following definitions are provided to facilitate claim interpretation:

Present invention: means at least some embodiments of the present invention; references to various feature(s) of the “present invention” throughout this document do not mean that all claimed embodiments or methods include the referenced feature(s).

First, second, third, etc. (“ordinals”): Unless otherwise noted, ordinals only serve to distinguish or identify (e.g., various members of a group); the mere use of ordinals implies neither a consecutive numerical limit nor a serial limitation.

Electrically Connected: means either directly electrically connected, or indirectly electrically connected, such that intervening elements are present; in an indirect electrical connection, the intervening elements may include inductors and/or transformers.

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output: unless otherwise explicitly specified, these words should not be taken to imply: (i) any particular degree of directness with respect to the relationship between their objects and subjects; and/or (ii) absence of intermediate components, actions and/or things interposed between their objects and subjects.

Seatback display: any seat with a dynamic display built into its back so that the dynamic display is facing away from a person sitting in the seat, without regard to: (i) specific display hardware (for example, CRT, LCD, plasma screen); (ii) specific seat hardware (for example, folding seat, permanently mounted seat, adjustable back angle seat; and/or (iii) whether the display is attachably detachable from the seat or permanently attached thereto; seatback displays do not include static display presentations such as flyers, advertising placards and words or pictures printed on the seatback itself.

Audience gathering place: any space where an audience is gathered primarily for the purpose of watching something; audience gathering places may include, but are not necessarily limited to, stadiums (indoor, outdoor, inflated domes), arenas, theatres, cinemas, classrooms, auditoriums and/or meeting rooms; audience gathering places do not include planes, trains or automobiles because passengers are not audience members and they are not generally present primarily for the purpose of watching something.

Display programming: any content for display on a dynamic display including, but not limited to video, still images and an interactive display that can receive viewer input.

Display hardware: includes both devices for presenting a visual display (for example, theatre seatback LCD, netbook computer, laptop computer) and also ports suitable for communicating display device therethrough to an individual audience member (for example, short-range personal wireless transmission link, data port suitable for use with a netbook computer).

User interface presentation system: includes one way communication (such as a display of advertising video on an LCD display to an audience member) and two way communication (for example, an html type communication with a laptop computer).

Substantially coextensive in spatial scope with an audience gathering place: means that the spatial scope of the network is broad enough that at least a majority of audience members at an audience gathering place can individually receive communications (for example, advertising displays) from the network, but that the network does not extend to any substantial number of users who are not at the audience gathering place; the network that is “substantially co-extensive in scope with an audience gathering place” may allow communications to or from a larger linked network, such as the internet, but there still must be a sufficiently local network that exists at the level of the audience gathering place; one example of a “substantially co-extensive in scope network” would be a wireless network that substantially limits access (for example, by way of password protection, by way of signal range) to audience members in the audience gathering place; another example of a “substantially co-extensive in scope network” would be an audience gathering place that has seatback displays in at least most seats that are in data communication with the “substantially co-extensive” network.

To the extent that the definitions provided above are consistent with ordinary, plain, and accustomed meanings (as generally shown by documents such as dictionaries and/or technical lexicons), the above definitions shall be considered supplemental in nature. To the extent that the definitions provided above are inconsistent with ordinary, plain, and accustomed meanings (as generally shown by documents such as dictionaries and/or technical lexicons), the above definitions shall control. If the definitions provided above are broader than the ordinary, plain, and accustomed meanings in some aspect, then the above definitions shall be considered to broaden the claim accordingly.

To the extent that a patentee may act as its own lexicographer under applicable law, it is hereby further directed that all words appearing in the claims section, except for the above-defined words, shall take on their ordinary, plain, and accustomed meanings (as generally shown by documents such as dictionaries and/or technical lexicons), and shall not be considered to be specially defined in this specification. In the situation where a word or term used in the claims has more than one alternative ordinary, plain and accustomed meaning, the broadest definition that is consistent with technological feasibility and not directly inconsistent with the specification shall control.

Unless otherwise explicitly provided in the claim language, steps in method steps or process claims need only be performed in the same time order as the order the steps are recited in the claim only to the extent that impossibility or extreme feasibility problems dictate that the recited step order (or portion of the recited step order) be used. This broad interpretation with respect to step order is to be used regardless of whether the alternative time ordering(s) of the claimed steps is particularly mentioned or discussed in this document.

What is claimed is:

1. An audience gathering place communication system, for use in conjunction with an audience gathering place, the system comprising:
a communication network hardware set structured and/or programmed to implement a communication network at least substantially co-extensive in spatial scope with the audience gathering place, the communication network hardware set being structured and/or programmed to communicate at least display data to a plurality of display devices over the communication network; and
a network communication sub-system, in data communication with the communication network, the network communication sub-system being structured and/or programmed to provide display data to the communication network in a form suitable for communication to a plurality of display devices located in the audience gathering place;
wherein the network communication sub-system comprises an advertising module structured and/or programmed to provide advertising-related display data to the communication network for communication to a plurality of display devices located in the audience gathering place.

2. The system of claim 1 wherein:
the audience gathering place is a theatre; and
the communication network hardware set and network communication sub-system are located in the theatre

3. The system of claim 1 further comprising a plurality of display devices located in the audience gathering place and in data communication with the communication network, wherein at least the advertising-related display data is communicated from the advertising module of the network communication sub-system to at least some of the plurality of display devices.

4. The system of claim 3 further comprising a plurality of seats located in the audience gathering place, wherein the plurality of display devices are respectively built into a seatback of each seat in the plurality of seats.

5. The system of claim 4 wherein the plurality of display devices each comprise user input hardware set structured and/or programmed a user input data to the communication network for communication back to the network communication sub-system.

6. The system of claim 5 wherein the user input hardware set comprises a touchscreen.

7. The system of claim 5 wherein the user input hardware set comprises a keyboard.

8. The system of claim 1 wherein the advertising module is structured and/or programmed to provide different advertising-related data to different display devices through the communication network.

9. The system of claim 8 wherein the advertising module is structured and/or programmed to provide advertising-related data that differs in content to different display devices through the communication network.

10. The system of claim 8 wherein the advertising module is structured and/or programmed to provide advertising-related data that differs in timing to different display devices through the communication network.

11. An audience gathering place system for use at a performance for an audience, the system comprising:
a plurality of seatback displays comprising a first seatback display and a second seatback display;
a video collection sub-system; and
a display programming sub-system;
wherein:
the video collection sub-system collects at least one video data stream(s) of the performance;
the display programming sub-system comprises a video stream input module structured and/or programmed to receive the at least one video stream(s) from the video collection sub-system; and
the display programming sub-system further comprises a display assembly and output module structured and/or programmed to receive the at least one video stream(s) from the video stream input module and to generate display programming for at least some of the plurality of seatback displays corresponding to at least a portion of the at least one video stream(s).

12. The system of claim 11 wherein:
the audience gathering system is located in a theatre; and
each of the plurality of seatback displays comprises a seat suitable for a theatre.

13. The system of claim 11 wherein:
the video collection sub-system is structured and/or located to collect a first video data stream of the performance and a second video stream of the performance; and
the video collection sub-system is further structured and/or located so that a viewing angle associated with the first video stream is substantially different than the viewing angle associated with the second video stream.
